(19) United States
(12) Patent Application Publication
(10) Pub. No.: US 2021/0042106 A1
(43) Pub. Date: Feb. 11, 2021

(54) SYSTEM AND METHOD FOR A SEMANTIC SERVICE DISCOVERY FOR A VEHICLE

(71) Applicant: Denso Corporation, Kariya (JP)

(72) Inventor: Ravi AKELLA, San Jose, CA (US)

(21) Appl. No.: 16/537,544

(22) Filed: Aug. 10, 2019

(51) Int. Cl. G06F 8/65; G07C 5/12; G05D 1/00; G07C 5/00; H04W 4/44

(52) U.S. Cl. CPC G06F 8/65; G07C 5/12; G05D 2201/0213; G07C 5/008; H04W 4/44; G05D 1/0088

(57) ABSTRACT

A driving system for a first vehicle comprises one or more sensors configured to obtain proximity data for one or more objects proximate the first vehicle and environment data of the first vehicle. The driving system also includes a vehicle transceiver configured to communicate with a remote infrastructure unit, and a processor in communication with the one or more sensors and the vehicle transceiver. The processor is programmed to output a notification identifying one or more applications from the remote infrastructure unit in response to the proximity data and environment data, wherein the one or more applications are configured to execute a driving assistance function at the first vehicle.

### TECHNICAL FIELD

The present disclosure relates to services and applications for vehicles.

### BACKGROUND

Vehicles may be pre-configured with various services that in-vehicle applications interact with. Vehicles may drive or be driven in various environments that do not have any applicable in-vehicle applications to utilize. It may be convenient for vehicles to update software or other services during a vehicle environment to allow for additional convenience to a user.

### SUMMARY

According to one embodiment, a vehicle computer system in a vehicle includes a first sensor in the vehicle and configured to survey an environment proximate to the vehicle. The first sensor is further configured to detect one or more objects outside of the vehicle. The vehicle computer system also includes a vehicle transceiver located in the vehicle and configured to receive data indicative of one or more applications from a remote infrastructure unit. The vehicle also includes a processor in communication with the first sensor and the vehicle transceiver and programmed to output a notification identifying the one or more service applications from the remote infrastructure unit in response to the environment of the vehicle. The vehicle further includes a display in communication with the processor and configured to display graphical images.

According to a second embodiment, a vehicle computer system in a vehicle including one or more sensors in the vehicle configured to survey an area proximate to the vehicle utilizing proximity data. The one or more sensors are further configured to detect one or more objects outside of the vehicle. The vehicle includes a vehicle transceiver located in the vehicle and configured to receive data indicative of one or more applications associated with a remote infrastructure unit. The vehicle includes a processor in communication with the one or more sensors and the vehicle transceiver and programmed to determine an environment of the vehicle utilizing at least the proximity data, download the one or more applications associated with the remote infrastructure unit from a remote server utilizing a semantic repository including a resource description framework, and output a notification identifying the one or more applications from the remote infrastructure unit in response to the environment of the vehicle.

According to a third embodiment, a driving system for a first vehicle comprises one or more sensors configured to obtain proximity data for one or more objects proximate the first vehicle and environment data of the first vehicle. The driving system also includes a vehicle transceiver configured to communicate with a remote infrastructure unit, and a processor in communication with the one or more sensors and the vehicle transceiver. The processor is programmed to output a notification identifying one or more applications from the remote infrastructure unit in response to the proximity data and environment data, wherein the one or more applications are configured to execute a driving assistance function at the first vehicle.

### BRIEF DESCRIPTION OF THE DRAWINGS

FIG. 1 illustrates a system architecture for a system 100 utilizing an embodiment of a semantic repository.

FIG. 2 illustrates a block diagram of a system utilizing a service provider 201.

FIG. 3 illustrates an example of a vehicle 301 utilizing the sematic repository.

FIG. 4 illustrates a flowchart 400 implemented on a vehicle to identify and load a semantic service.

### DETAILED DESCRIPTION

Embodiments of the present disclosure are described herein. It is to be understood, however, that the embodiments are merely examples and other embodiments can take various and alternative forms. The figures are not necessarily to scale; some features could be exaggerated or minimized to show details of particular components. Therefore, specific structural and functional details shown herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Vehicles may include pre-configured services that in-vehicle applications that the vehicle may interact with. Domain ontologies in an automotive setting may be used for providing a semantic basis for describing automotive parts, inventory, dependencies among various subsystems, vehicle specifications, vehicle sales, fault diagnosis, etc. The internet may rely heavily on semantic principles of linking open data to describe various interacting objects of web systems.

Future connected vehicle technology may rely on providing the user with a broad range of services for safety, convenience, and mobility. In the disclosure described below, the system may leverage cloud or fog services (e.g., using edge devices to carry out computation, storage, communication, etc.) at the vehicular edge. By creating a dynamic knowledge map of the services in the vehicular environment, the system can discover and provide a way to interact with new services the vehicle is not equipped for.

By maintaining a dynamic semantic knowledge map of services and application contexts from the multi-domain environment of the vehicle (such as surround traffic, smart city infrastructure, user devices), new connected services can be discovered and presented to the user (e.g., a dashboard user interface (UI) or applied to vehicle controls), which may also include the service interaction components.

Semantic web technologies evolved as an extension to the world wide web to extract and link meaningful knowledge from data on web pages. Such a notion gives the power to establish a semantic basis for search engines and knowledge mapping systems. An ontology may define concepts, classes and their relationships commonly used to semantically organize domain-specific data. Semantic knowledge maps are created using single or multi-domain ontologies expressed in schema languages such as Resource Description Framework Schema (RDFS) or Web Ontology Language (OWL). Data in such languages are usually expressed in Resource Description Framework (RDF) format which refers to expressing statements in triples of subject, predicate, object. A database used to store such RDF triples may be referred to as a semantic repository. Services may include services that are provided by infrastructure points provided by municipals, such as traffic lights, road side units, toll booths, etc. The system can provide appropriate services on a user's display based on the vehicle context.

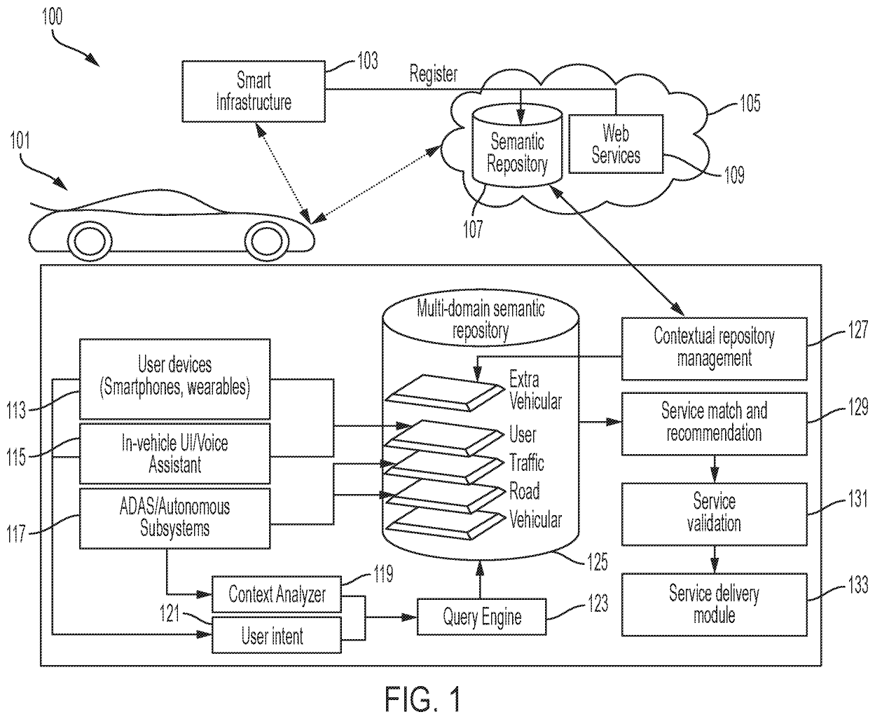

FIG. 1 illustrates a system architecture for a system 100 utilizing an embodiment of a semantic repository. A smart infrastructure unit 103 may refer to road side units and objects (or other infrastructures), which may include but are not limited to street lights, traffic signals, toll gates, etc. The smart infrastructure units 103 may include transceivers that can communicate information and data to a vehicle 101 for purposes of utilizing such data in the vehicle 101. The vehicle 101 may be a passenger vehicle, commercial truck, motorcycle, autonomous vehicle, semi-autonomous vehicle, or any type of motor vehicle. The smart infrastructure units 103 (e.g., remote infrastructure unit) may be located along a road side or within a point-of-interest (POI), such as a restaurant, bank, parking structure, home, office location, etc. The smart infrastructure unit 103 may communicate various data to the vehicle 101 to identify possible services 109 that may be utilized. In another embodiment, the vehicle 101 may communicate directly with a cloud 105 to identify web services 109 or applications for the vehicle 101 to utilize.

The system 100 may include an advanced driver assistance system (ADAS)/autonomous subsystem 117 to control the vehicle 101. The ADAS/autonomous subsystem 117 may include a controller or processor in communication with memory. The memory may store instructions and commands. The instructions may be in the form of software, firmware, computer code, or some combination thereof. The memory may be in any form of one or more data storage devices, such as volatile memory, non-volatile memory, electronic memory, magnetic memory, optical memory, or any other form of data storage device. In one example, the memory may include 2 Gigabyte (GB) Double Data Rate 3 Synchronous Dynamic Random-Access Memory (DDR3 SDRAM), as well as other removable memory components such as a 128 GB micro secure digital (SD) card.

The controller may be in communication with various sensors, modules, and vehicle systems both within and remote from a vehicle. The vehicle 101 and ADAS/autonomous subsystem 117 may include such sensors, such as various cameras, a light detection and ranging (LIDAR) sensor, a radar sensor, an ultrasonic sensor, or other sensor for detecting information about the surroundings of the vehicle 101, including, for example, other vehicles, lane lines, guard rails, objects in the roadway, buildings, pedestrians, etc. In the example shown in FIG. 1, the ADAS/autonomous subsystem 117 may include a forward LIDAR sensor, a forward radar sensor, a forward camera, a corner LIDAR sensor, a corner radar sensor. FIG. 1 is an exemplary system and the ADAS/autonomous subsystem 117 may include various sensors, and sensors of varying types. The ADAS/autonomous subsystem 117 may be equipped with additional sensors at different locations within or on the vehicle 101, including additional sensors of the same or different type.

The ADAS/autonomous subsystem 117 may also include a forward LIDAR sensor and corner LIDAR sensor, each configured to measure a distance to a target arranged external and proximal to the vehicle 101 by illuminating the target with a pulsed laser light and measuring the reflected pulses with a sensor. The LIDAR sensors may then measure the differences in laser return times. This, along with the received wavelengths, may then be used to generate a digital three-dimensional representation of objects. The LIDAR sensors may have the ability to classify various objects based on the three-dimensional rendering of the objects. For example, by determining a shape of the target, the LIDAR sensors may classify a target as a vehicle, curb, roadblock, building, pedestrian, signage, etc. The LIDAR sensor may work in conjunction with other vehicle components, such as an Engine Control Unit (ECU) and other sensors, to classify various targets outside of the vehicle 101. The LIDAR sensors may include laser emitters, laser receivers, and any other suitable LIDAR autonomous vehicle sensor components. The LIDAR sensors may be arranged within a housing configured to rotate to facilitate scanning of the environment. The forward LIDAR sensor may be used to determine what vehicles and objects are in the front peripheral of the vehicle. The corner LIDAR sensor may also be utilized to detect and classify objects. The corner LIDAR sensor may also be used to enhance a vehicle's peripheral view of the vehicle's surroundings.

The sensors of the ADAS/autonomous subsystem 117 may be configured to detect and classify objects to enhance a vehicle's peripheral view of the vehicle's surroundings or help identify contextual events surrounding the vehicle environment. The radar sensors may be utilized to help or enhance various vehicle safety systems. The forward radar sensor may be built into a front bumper of the vehicle to determine that an object is ahead of the vehicle. The corner radar sensor may be located in the rear bumper or the side of the vehicle. The corner radar sensor may be utilized to determine if objects are in a driver's blind spot, as well as detecting vehicles or objects approaching from the rear on the left and right when reversing. Such functionality may allow a driver to navigate around other vehicles when changing lanes or reversing out of a parking space, as well as assist in autonomous emergency braking in order to avoid collisions that may be imminent.

The sensors, such as a LIDAR sensor or a radar sensor, may be mounted anywhere on the vehicle. For example, it is possible for a LIDAR sensor to be mounted on a roof of a vehicle with a 360-degree view of the vehicle's surroundings. Furthermore, the various sensors may surround the vehicle to provide a 360-degree view of the vehicle's surroundings. The vehicle may also be equipped with one or more cameras, one or more LIDAR sensors, one or more radar sensors, one or more ultrasonic sensors, and/or one or more other environmental sensors. Actuators may be utilized to adjust or control an angle of the field of view of the various sensors.

The ADAS/autonomous subsystem 117 may also utilize a forward camera. The forward camera may be mounted in the rear-view mirror. The forward camera may also be facing out of the vehicle cabin through a vehicle's windshield to collect imagery data of the environment in front of the vehicle. The forward camera may be utilized to collect information (e.g., utilizing proximity data) and other data regarding the front of the vehicle and for monitoring the conditions ahead of the vehicle. The camera may also be used for imaging the conditions ahead of the vehicle and correctly detecting the positions of lane markers as viewed from the position of the camera and the presence/absence, for example, of lighting of the head lights of oncoming vehicles. For example, the forward camera may be utilized to generate image data related to a vehicle's surroundings such as lane markings ahead, and for other object detection. A vehicle may also be equipped with a rear camera for similar circumstances, such as monitoring the vehicle's environment around the rear proximity of the vehicle.

The ADAS/autonomous subsystem 117 may also include a global positioning system (GPS) that detects or determines a current position of the vehicle. In some circumstances, the GPS may be utilized to determine a speed that the vehicle is traveling. The ADAS/autonomous subsystem 117 may also include a vehicle speed sensor that detects or determines a current speed that the vehicle is traveling. The ADAS/autonomous subsystem 117 may also include a compass or three-dimensional gyroscope that detects or determines a current direction of the vehicle. Map data may be stored in the memory. The GPS may be utilized to update the map data. The map data may include information that may be utilized with the ADAS/autonomous subsystem 117. Such ADAS map data information may include detailed lane information, slope information, road curvature data, lane marking-characteristics, etc. Such ADAS map information may be utilized in addition to traditional map data such as road names, road classification, speed limit information, etc. The controller may utilize data from the GPS, as well data/information from the gyroscope, vehicle speed sensor, and map data, to determine a location or current position of the vehicle.

The vehicle 101 may also include a human-machine interface (HMI) display. The HMI display may include any type of display within a vehicle cabin. Such HMI display may include a dashboard display, navigation display, multimedia display, heads-up display, thin-film transistor liquid-crystal display (liquid crystal display, thin-film-transistor, etc.), etc. The HMI display may also be connected to speakers to output sound related to commands or the user interface of the vehicle. The HMI display may be utilized to output various commands or information to occupants (e.g., driver or passengers) within the vehicle. For example, in an automatic braking scenario, the HMI display may display a message that the vehicle is prepared to brake and provide feedback to the user regarding the same. The HMI display may utilize any type of monitor or display to display relevant information to the occupants.

In addition to providing visual indications, the HMI display may also be configured to receive user input via a touch-screen, user interface buttons, etc. The HMI display may be configured to receive user commands indicative of various vehicle controls such as audio-visual controls, autonomous vehicle system controls, certain vehicle features, cabin temperature control, etc. A vehicle controller may receive such user input and in turn command a relevant vehicle system of the component to perform in accordance with the user input.

The controller can receive information and data from the various vehicle components including LIDAR sensors, radar sensors, forward camera, the GPS, and HMI display. The vehicle 101 may utilize such data to provide vehicle functions that may relate to driver assistance or autonomous driving (e.g., ADAS/autonomous subsystem 117). For example, data collected by the LIDAR sensors and the forward camera may be utilized in context with the GPS data and map data to provide or enhance functionality related to adaptive cruise control, automatic parking, parking assist, automatic emergency braking (AEB), etc. The ADAS/autonomous subsystem 117 may be in communication with various systems of the vehicle (e.g., the engine, transmission, brakes, steering mechanism, display, sensors, user interface device, etc.). For example, a vehicle controller can be configured to send signals to the brakes to slow the vehicle 101, or the steering mechanism to alter the path of vehicle 101, or the engine or transmission to accelerate or decelerate the vehicle 101. The vehicle 101 can be configured to receive input signals from the various vehicle sensors to send output signals to the display device, for example. The vehicle 101 may also be in communication with one or more databases, memory, the internet, or networks for accessing additional information (e.g., maps, road information, weather, vehicle information, etc.).

The system 100 may include the web services 109 located in the cloud 105. The web services 109 may be public or private cloud hosted applications that are designed to offer specific services (e.g., car sharing, navigation assistance, streaming music, etc.). A multi-domain vehicular sematic repository (VSR) 125 may hold ontological information that describes the vehicle itself in the vehicular ontology (such as sensors, signals, device specifications, etc.). The extra vehicular ontology may provide information regarding information that describes objects and other vehicles surrounding the vehicle, utilizing sensors and transceivers to obtain such information. The road ontology may be assumed to be provided by the navigation system, etc. The road ontology may include information from the map database regarding lane information, road class, road curvature, etc. The ADAS/autonomous subsystem 117 may include a subsystem for lane keeping, perception, trajectory planning that is utilized to update the semantic repository's 107 road and traffic information. Thus, the semantic repository 107 is updated with live information based on the vehicle's 101 context. The user ontology may capture the general specification of user devices and in-vehicle applications (e.g., user interface (UI), voice assistance, etc.) to provide interoperability. In one example, the multi-domain VSR 125 may be stored on the vehicle 101 for quicker access given that the vehicle 101 does not need to communicate with the cloud 105.

The vehicle 101 may be in communication with a context analyzer 119. The context analyzer 119 may be a software module that identifies current vehicular operational state, driving context, and geo-location to construct a relevant query. Thus, the context analyzer 119 may be in communication with various vehicle sensors and hardware to collect relevant data. In one example, the system 100 may be in communication with a radar, LIDAR, camera, or other sensor to identify vehicles and objects outside of the vehicle 101. In another example, the system 100 may be in communication with a GPS receiver to identify a location of the vehicle 101. For example, on a freeway merge that the host vehicle is predicted to perform, the context analyzer 119 may find a matching service offered by a road side unit that offers freeway merge assistance.

In one example, the system's context analyzer 119 may identify that the vehicle's current environment or driving situation may be a freeway merge that the vehicle should be predicted to perform. The context analyzer 119 may work with the system 100 to find a matching service offered by a road side unit that offers the freeway merge assistance instructions.

The context analyzer 119 may be in communication with the ADAS/autonomous subsystem 117 of the vehicle 101. Thus, the context analyzer 119 may communicate with controllers and other data utilized by the ADAS/autonomous subsystem 117 of the vehicle to predict upcoming driving scenarios or maneuvers. The upcoming maneuvers and scenarios may be useful for the context analyzer 119 to identify possible services that may be beneficial for a driver or user of a vehicle.

The context analyzer 119 may also be in communication with various user devices 113. The user devices 113 may include a mobile phone, wearable device, tablet, or other electronic device. The user devices 113 may include data regarding the user that could be utilized by the context analyzer 119. For example, the context analyzer 119 may communicate with controllers and other data utilized by user devices 113 of the vehicle 101 to gather user data of a driver/user of the vehicle 101. For example, the user devices 113 may identify a driver/user of the vehicle 101, whether a phone call is taken place via a mobile device, music information being played or not, etc. The identification may be utilized by the context analyzer 119 to identify possible services that may be beneficial for a driver or user of a vehicle.

A user intent module 121 may identify a query by a user (e.g., voice recognition command, or an input via a user interface.). Thus, the user intent module 121 may be utilized to anticipate a user's upcoming maneuver or action. For example, if a user sends a voice request to get directions to their home, the user intent module 121 may anticipate that the user will be driving on certain streets. In another example, if the user is requesting to drive to a destination several hundred miles away, the user intent module 121 may anticipate that the user may need to stop for gasoline or a charge. The user intent module 121 may aggregate data related to any query that the user sends to a query engine 123. The query engine 123 may be responsible for translating a query from the user intent module 121 and context analyzer 119 into a semantically valid construct. The query engine 123 may also optimize and perform the query on the semantic repository 107. For example, the query may be to a RDFS database that may be constructed using a specialized language, such as SPARQL.

The vehicle 101 may include an in-vehicle user interface (e.g., an HMI or a voice assistant 115). The voice assistant 115 may be a voice recognition system that allows spoken commands to be utilized as an input or interface to operate various vehicle systems and subsystems. For example, the voice assistant 115 may be utilized to speak an address into a vehicle's navigation system. The voice assistant 115 may be utilized to speak commands, as opposed to utilizing a traditional input on an HMI that requires utilization of physical buttons, touch screen, haptic device, etc.

The system 100 may include the semantic repository 107 located in the cloud 105. The semantic repository 107 may also store information at the vehicle in another example, or a hybrid approach with some information located in the vehicle 101 and some information in the cloud 105. In yet another example, the vehicle 101 may also include its own vehicle semantic repository. The vehicle semantic repository may be a subset of the semantic repository 107 that is located on the cloud, as storage may be more limited in the vehicle as opposed to the cloud. The maintenance and utilization of multi-domain ontologies in the multi-domain VSR 125 may enhance a user's experience in various contextual settings.

In another example, the system 100 may determine that the service 109 is appropriate for the user. The service 109 may be downloaded from the cloud 105 (e.g., for restaurant and services) or from a road side unit. The services 109 may be public or private cloud hosted applications that are designed to offer specific services, such as car sharing, navigation assistance, streaming music, etc. For example, the system 100 may identify a driver of the vehicle 101 based on a mobile device, key fob, biometric recognition, etc. The system 100 may utilize such information to conduct a verification that the appropriate service is applied given an age, experience as a driver, license level (e.g., does the driver have a chauffer license or another license type, etc.). Various attributes that may apply at the user level may be utilized to verify appropriateness of the service to the user.

In another example, the system 100 may identify the traffic situation surrounding the vehicle 101. Traffic information may include the traffic flow of a street or route that is provided by map data that may be on-board or off-board (e.g., located in the cloud, etc.). Furthermore, the traffic information may utilize vehicle sensors to identify various objects (e.g., pedestrians, vehicles, etc.) that may be proximate to the vehicle 101 as gathered by proximity data collected by the sensors and computed by a vehicle processor.

In another example, the system 100 may utilize the surrounding road information around the vehicle 101. The road information may include the functional road class that the vehicle is on (e.g., freeway, residential road, main road, etc.), lane lines, traffic restrictions, etc. The road information may be collected from off-board servers (e.g., the cloud) or through an on-board map database that defines road information.

The semantic repository 107 may include web services 109 that are only available for a specific vehicle. For example, the services 109 may be based on the type of vehicle, length of vehicle, powertrain of the vehicle (e.g., battery versus internal combustion engine versus hybrid, etc.), and other attributes related to the vehicle. The system 100 may determine if the service 109 is geared to the appropriate vehicle to apply the service 109.

A contextual repository management module 127 may be utilized to synchronize the semantic repository 107 and the multi-domain VSR 125. The semantic repository 107 and the multi-domain VSR 125, for example, may have different versions that may be attempted to be utilized in the vehicle 101. For example, the semantic repository 107 may include an updated software version with new features or software patches. However, the vehicle 101 may include a multi-domain VSR 125 that is utilizing an older version or incorrect version. The contextual repository management module 127 may utilize the vehicle's current location, timing, version of software, vehicle's contextual environment, and other attributes to synchronize the multi-domain VSR 125. The contextual repository management module 127 may also ensure that stale entries are removed that are no longer valid in the current context or have expired via a predefined timeout (e.g., time based threshold). A service and match recommendation module 129 may be utilized to determine the compatibility of the web service 109 with the vehicle 101. The service and match recommendation module 129 may utilize a user query to identify the most appropriate results of a web service 109 given the user context. For example, if a vehicle is driving on a freeway, the service and match recommendation module 129 may confirm that the most appropriate web service 109 to be utilized is appropriate for freeway driving. The service match and recommendation module 129 may parse the results of a valid in-vehicle query and filter them based on a weighting method to prioritize and render only the context appropriate services.

A service validation module 131 may be utilized to ensure that the service 109 or application is proper for the vehicle. The service validation module 131 performs code analysis, integrity checks, and may execute the necessary code downloaded from a service provider that is used to utilize the service 109 in a sandbox environment that is specific to the host vehicle. It is possible that a particular offering from a service provider cannot be fully utilized in the vehicle platform owing to difference in factors such as implementation, version, security, context applicability. The service validation module 131 may confirm that the appropriate service is applied based on the context of the vehicle 101. The service validation module 131 may verify that a given service 109 works with the vehicle's specifications to ensure a service 109 works for a given user. For example, the service validation module 131 may determine if a vehicle includes a heads-up display if a specific service utilizes the heads-up display.

A service delivery module 133 may be utilized to communicate with a remote infrastructure unit and download the applicable applications or other data necessary. The service delivery module 133 may be in communication with a vehicle via the transceiver. Service delivery module 133 may parse the service 109 information to facilitate service interaction via a HMI or the native implementation (that is specific to the car). The service delivery module 133 may also work to transfer any events related to embedded control from the application to underlying in-vehicle platform.

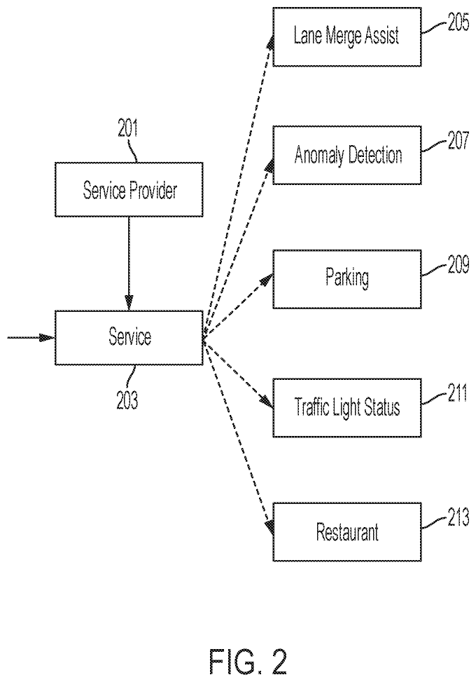

FIG. 2 illustrates an exemplary block diagram of a system, such as the one described in FIG. 1, utilizing a service provider 201. The service provider 201 may first register with the system 100 in FIG. 1 by updating a knowledge map structure ontology in the semantic repository 107. In one example, this update process may insert Resource Description Framework (RDF) triples describing the services offered by the service provider 201. The RDF triples may follow the format <“Service Provider”, “hasService”, “Service”> where “hasService” is a relationship between the concepts “Service Provider” and “Service” already defined in the ontology in the semantic repository 107. The RDF triples describing the services (e.g., parking) offered by service provider 201 are captured using the “isInstanceOf” relationship between service 203 and parking service 209. The semantic query mechanism may rely on such defined relationships between the concepts and their instances in the semantic repository 107 or multi-domain VSR 125.

The service provider 201 may include various services from a variety of POIs, such as a parking lot, restaurant, bank, etc. The system may identify a service 203 for the vehicle to utilize. For example, the service 203 may include a lane-merge assist functionality 205. The lane-merge assist functionality 205 may work with various systems of the vehicle to assist in lane merging in a specific location. In another example, the semantic repository 107 may include an anomaly detection service 207. The anomaly detection service 207 may be utilized to detect items, events, or observations that raise suspicion amongst a vehicle system. For example, the anomaly detection service 207 may be utilized to identify heavy traffic scenarios based on an event (e.g., a concert that occurred at a local stadium that caused traffic for nearby roads or another situation). The service 203 may also include the parking service 209 that may assist the user in a parking situation that is identified by the context analyzer 119. In such an example, the service provider 201 may be a parking lot that includes a remote infrastructure unit configured to communicate with the vehicle. In another example, the service 203 may include traffic light status 211. In yet another example, the system may include a restaurant service 213. The restaurant service 213 may be utilized to make reservations, order food, display menus and pricing, and other restaurant-ordering information at the vehicle. Each restaurant may have their own individual application to be utilized for the vehicle, or in other examples, a standard interface may be utilized for the restaurant. For example, an interface may be utilized for different restaurant franchises or establishments that utilize an application program interface (API) to interact with a vehicle system.

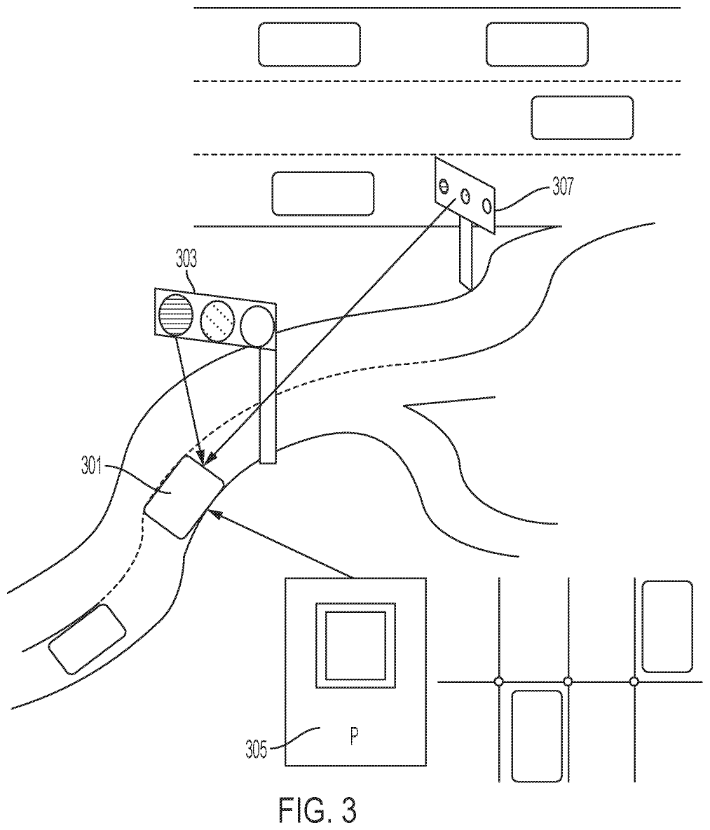

FIG. 3 illustrates an example of a vehicle 301 utilizing the contextual sematic repository system 100. In one use case, the semantic awareness of the vehicle 301 may allow a vehicle to identify nearby services when stopped at a traffic light 303, which is one example of a remote infrastructure unit 103. In one example, the traffic light 303 may be equipped with a transceiver to communicate with the vehicle. The traffic light 303 can communicate traffic light information/data to the vehicle via a transceiver. The vehicle 301 may utilize such data to display the current traffic light status, a signal timer, or other traffic information on the vehicle in response to utilizing the traffic light application (which may be downloaded from the traffic light or may be already present on the vehicle). In another example, a vehicle's start/stop system may utilize the data received from the traffic light 303 to identify when a vehicle's engine should be turned on, if the engine is idle at the traffic light 303.

In another example, the vehicle 301 may be able to communicate with a lane-merge assist unit 307. The lane-merge assist unit 307 may be located near a ramp that allows a vehicle to merge onto the freeway. The lane-merge assist unit 307 may offer speed limit information, road class information, and other context-related information to the vehicle. The application may offer a speed advisory or automatic speed maneuver of the vehicle on the ramp that leads to the freeway.

In yet another example, the vehicle 301 may be able to communicate with a parking provider 305. The parking provider 305 may be equipped with a transceiver that communicates parking information to the vehicle 301 via a transceiver. Such parking information may include information regarding hours of operation, current availability, pricing, etc. An application may be associated with the parking provider 305 to allow for reservations and other functions associated with the parking provider 305. The parking provider application may be sent to the vehicle 301 to be displayed on a vehicle interface.

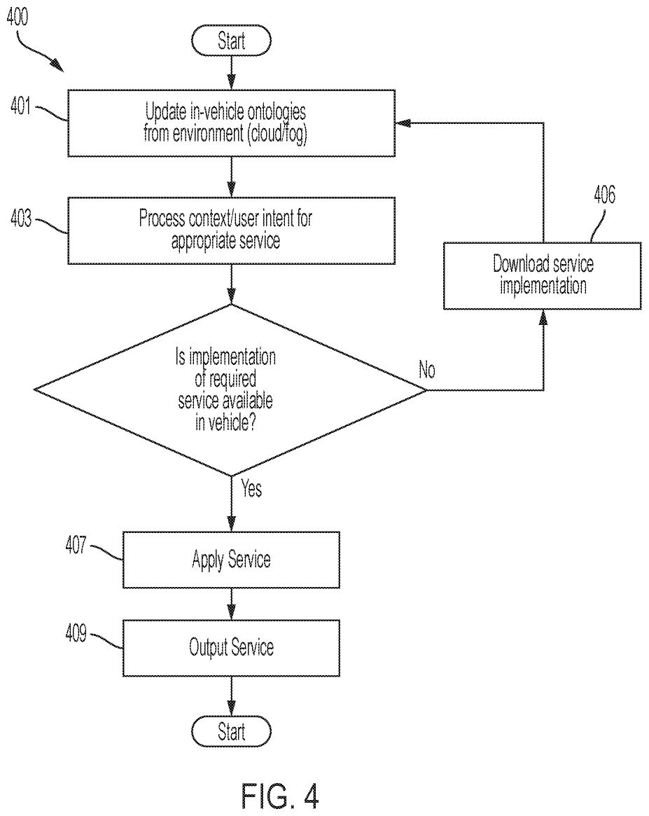

FIG. 4 illustrates a flowchart 400 implemented on a vehicle to identify and load a semantic service. The vehicle may collect environment data and update vehicle ontologies at step 401. The environment data may be utilized to determine a contextual environment of the vehicle to understand driving situations or upcoming scenarios. For example, data collected from various sensors and other inputs may be collected and aggregated to determine the vehicle context. In one example, the vehicle may utilize a speed sensor data and map data to identify that the vehicle is traveling fast on a freeway. The system may utilize cloud computing or fog computing (e.g., utilizing edge devices for computing, storage, etc.) to identify the appropriate ontologies to update.

At step 403, the system may process the context and user intent to identify the appropriate service. The system may determine if a service should be made available to the user after analyzing the contextual data and user intent. The system may utilize the vehicle's environment information (e.g., utilized based off the collected data from sensors and other vehicle hardware) to determine if an appropriate service may be applied at the vehicle. For example, GPS data and data collected from a vehicle speed sensor may identify the need for a freeway-related service. The service may be downloaded from a remote infrastructure unit or other auxiliary site, or the service may already be available at the vehicle.

At decision 405, the system may determine if implementation of the required service is available in the vehicle. The vehicle may determine if a multi-domain semantic repository includes an appropriate service given the vehicle's context. The vehicle may determine if the appropriate service is available by looking to the vehicle first and then looking to the cloud based semantic repository and identifying the appropriate service available. The vehicle may determine if the service available at the vehicle is the most appropriate given the context of the vehicle's environment, as well as the available hardware to utilize at the vehicle. For example, the vehicle may determine if an auto parking sensor is available for a parking service available to utilize. The vehicle may utilize the vehicle transceiver to communicate with the remote infrastructure unit to download the application or service. In another embodiment, the vehicle may utilize a transceiver to download the service from the cloud or remote server.

If the implementation of the required service is not available at the vehicle, the system may download the appropriate service at step 406. The system may then download the service from a remote server (e.g., the cloud) or via the smart infrastructure (e.g., remote infrastructure unit). The vehicle may utilize the vehicle transceiver to communicate with the remote infrastructure unit to download the application or service. In another embodiment, the vehicle may utilize a transceiver (e.g., cellular modem or a mobile phone) to download the service from the cloud or remote server. If the vehicle already includes the required service, the system may skip to download a new service or implementation of the service.

At step 407, the system may apply the service or application. The system may determine how to render the HMI on a display or other interface. For example, the system may determine the available vehicle functions that a vehicle is equipped with. The application or service may determine what vehicle hardware to utilize given the available functions or service. For example, if a vehicle service may utilize a heads-up display (HUD) to render graphics, the system may utilize the HUD. If a vehicle does not have a HUD, the system may render the HMI utilizing a different interface (e.g., navigation screen or infotainment cluster).

At step 409, the system may render the service or application by rendering the HMI on the vehicle system. Thus, the application or service may run at the appropriate use case scenario, activate a function corresponding to the application, and allow for interaction of the service or application, and output to an interface related to the application or service. For example, a driver assistance function may be utilized in response to the service application. In one example, the application may assist in lane merging at a freeway. Thus, the service may execute driving functions to allow a vehicle to merge onto a freeway. The service may work with a vehicle navigation map database to identify road curvature, lane information, road-slope information, and other information related to the road. Furthermore, the service may work with an ADAS system to maneuver the vehicle (e.g., steer the vehicle), accelerate, decelerate, brake, or execute other driving functions.

The processes, methods, or algorithms illustrates herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field Programmable Gate Arrays (FPGAs), state machines, controllers or other hardware components or devices, or a combination of hardware, software and firmware components. The words used in the specification are words of description rather than limitation, and it is understood that various changes can be made without departing from the spirit and scope of the disclosure. For example, the term module may describe a processor, controller, or any other type of logic circuitry that responds to and processes instructions utilized by a computer. A module may also include memory or be in communication with memory that executes instructions. Additionally, the term module may be utilized in software to describe a part of a program (or multiple programs) that have routines. Furthermore, an application may be a program or a set of software routines.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle computer system in a vehicle, comprising:
a first sensor in the vehicle and configured to survey an environment proximate to the vehicle, wherein the first sensor is further configured to detect one or more objects outside of the vehicle;
a vehicle transceiver located in the vehicle and configured to receive data indicative of one or more service applications from a remote infrastructure unit;
a processor in communication with the first sensor and the vehicle transceiver and programmed to output a notification identifying the one or more service applications from the remote infrastructure unit in response to the environment of the vehicle; and
a display in communication with the processor and configured to display graphical images.

2. The vehicle computer system of claim 1, wherein the processor is further programmed to be in communication with the display and output a graphical user interface associated with the one or more service applications from the remote infrastructure unit.

3. The vehicle computer system of claim 1, wherein the one or more service applications are configured to execute driving commands in response to the environment of the vehicle.

4. The vehicle computer system of claim 1, wherein the vehicle transceiver is configured to communicate with at least a traffic light or parking provider.

5. The vehicle computer system of claim 4, wherein the processor is further programmed to output a current traffic status and signal timer data in response to selecting one or more service applications associated with the traffic light.

6. The vehicle computer system of claim 4, wherein the processor is further programmed to output a parking status in response to selecting one or more service applications associated with the parking provider.

7. The vehicle computer system of claim 1, wherein the processor is further programmed to automatically download the one or more service applications from a remote infrastructure unit in response to determining a version of the one or more service applications located at the vehicle being incompatible with hardware of the vehicle.

8. The vehicle computer system of claim 1, wherein the processor is further programmed to download the one or more service applications in response to an input received at the vehicle by a user of the vehicle.

9. A vehicle computer system in a vehicle, comprising:
one or more sensors in the vehicle, wherein the one or more sensors are configured to survey an area proximate to the vehicle utilizing proximity data, wherein the one or more sensors are further configured to detect one or more objects outside of the vehicle;
a vehicle transceiver located in the vehicle and configured to receive data indicative of one or more applications associated with a remote infrastructure unit; and
a processor in communication with the one or more sensors and the vehicle transceiver and programmed to:
determine an environment of the vehicle utilizing at least the proximity data;
download one or more applications associated with the remote infrastructure unit from a remote server utilizing a semantic repository including a resource description framework; and
output a notification identifying the one or more applications from the remote infrastructure unit in response to the environment of the vehicle.

10. The vehicle computer system of claim 9, wherein the processor is further programmed to be in communication with a display of the vehicle computer system and output a graphical user interface associated with the one or more applications from the remote infrastructure unit.

11. The vehicle computer system of claim 9, wherein the processor is further programmed to execute a vehicle-based application in response to the data indicative of the one or more applications associated with the remote infrastructure unit.

12. The vehicle computer system of claim 9, wherein the processor is further programmed to automatically download the one or more applications from the remote infrastructure unit in response to determining a version of the one or more applications located at the vehicle being an older version.

13. The vehicle computer system of claim 9, wherein the vehicle transceiver is configured to communicate with at least a traffic light or parking provider.

14. The vehicle computer system of claim 13, wherein the processor is further programmed to be in communication with a display of the vehicle computer system and output a current traffic status and signal timer data in response to the environment of the vehicle.

15. The vehicle computer system of claim 13, wherein the processor is further programmed to be in communication with a display of the vehicle computer system and output a parking status in response to the environment of the vehicle.

16. The vehicle computer system of claim 9, wherein the processor is further programmed to automatically download the one or more applications from the remote infrastructure unit in response to the proximity data.

17. The vehicle computer system of claim 9, wherein the processor is further programmed to download the one or more applications in response to an input received at the vehicle.

18. A driving system for a first vehicle, comprising:
one or more sensors configured to obtain proximity data for one or more objects proximate the first vehicle and environment data of the first vehicle;
a vehicle transceiver configured to communicate with a remote infrastructure unit; and
a processor in communication with the one or more sensors and the vehicle transceiver and programmed to:
output a notification identifying one or more applications from the remote infrastructure unit in response to the proximity data and environment data, wherein the one or more applications are configured to execute a driving assistance function at the first vehicle.

19. The driving system of claim 18, wherein the vehicle transceiver is further configured to communicate data indicative of one or more applications from the remote infrastructure unit.

20. The driving system of claim 19, wherein the processor is further programmed to execute the driving assistance function in response to the data indicative of the one or more applications from the remote infrastructure unit.
